(19) United States
(12) Patent Application Publication
(10) Pub. No.: US 2007/0271964 A1
(43) Pub. Date: Nov. 29, 2007

(54) Method and Device for Producing a Hollow Quartz-Glass Cylinder

(75) Inventor: Michael Huenermann, Alzenau (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Tenevo GmbH, Hanau (DE)

(21) Appl. No.: 11/630,540

(22) PCT Filed: Jul. 19, 2005
(86) PCT No.: PCT/EP05/07864

§ 371 Date: Dec. 22, 2006

(30) Foreign Application Priority Data
Jul. 20, 2004 (DE) 10 2004 035 086.8

(51) Int. Cl. C03B 37/075

(52) U.S. Cl. 65/494; 65/428

(57) ABSTRACT

In a known method for producing a hollow quartz-glass cylinder by means of the soot method , a porous soot tube with a central inner bore is produced by the deposition of SiO₂ particles on the outer surface of a support that rotates about its longitudinal axis. The soot tube is then heated in a furnace and sintered. During said process, the tube is held by a retaining device, which comprises an elongated shaping element that projects into the inner bore. The soot tube collapses onto said shaping element thus forming the hollow cylinder. The aim of the invention is to develop said process to provide an economic method that can be used to obtain quartz-glass hollow cylinders with a narrower inner bore. To achieve this, during the sintering process, a pressure differential is at least temporarily generated and maintained between a lower internal pressure prevailing in the inner bore of the soot tube and a higher external pressure that exists outside the inner bore. The invention also relates to a device that is suitable for carrying out said method.

The present invention relates to a method for producing a hollow cylinder of quartz glass by producing a porous soot tube with a central inner bore by depositing SiO₂ particles on an outer surface of a support rotating about its longitudinal axis, and by heating and sintering the soot tube in a furnace, whereby the soot tube is supported by means of a holding device, the holding device comprising an elongated shaping element which projects into the inner bore and onto which the soot tube is collapsed with formation of the hollow cylinder.

Furthermore, the present invention relates to a device comprising a furnace for sintering a porous soot tube comprising an inner bore, a heating device for heating and sintering the soot tube, a holding device for holding the soot tube in vertical orientation in the furnace, and an elongated inner tube which projects into the inner bore and has a gas permeable wall and onto which the soot tube is collapsed with formation of a hollow cylinder of quartz glass.

Hollow cylinders of synthetic quartz glass are used as intermediate products for making preforms for optical fibers. In the so-called “soot method”, their manufacture comprises a deposition process with formation of a porous blank of SiO₂ particles (here called “soot body” or “soot tube”), and a sintering process for vitrifying the soot body.

DE 197 36 949 C1 discloses a method for producing a tubular soot body according to the “OVD method” (outside vapor deposition). In said method, fine SiO₂ particles are formed by means of a flame hydrolysis burner by flame hydrolysis of SiCl₄ and are deposited layer by layer on the outer surface of a support rod which is clamped with both ends in a lathe and rotates about its longitudinal axis. The result of the deposition process is a soot tube the inner bore of which represents the outer contour of the support rod. The support rod consists, for example, of aluminum oxide, graphite or quartz glass.

Hollow cylinders having a ratio of outer diameter to inner diameter that is as great as possible are often desired. In the simplest case this would be accomplished by way of a soot tube having an inner bore that is as small as possible and an outer diameter that is as large as possible. However, mechanical roadability and thermal resistance of the support rod and also the deposition efficiency turn out to be limiting factors. On the one hand, the support rod should have an outer diameter that is as small as possible so as to leave a small inner bore. The smaller the outer diameter of the support rod is at the beginning of the deposition process, the lower is however the deposition efficiency. On the other hand, the support rod must carry the weight of the soot tube that can easily exceed hundred kilos, and it must withstand a high thermal load for several hours during the deposition process. That is why a corresponding, mechanically stable, i.e. normally thick, support rod is indispensable for the manufacture of heavy soot tubes in order to prevent breakage or deflection and to achieve an adequate deposition efficiency.

The sintering operation (also called “vitrification”) for the soot body is e.g. described in EP 701 975 A1, which also discloses a device of the above-mentioned type. After the support rod has been removed from the inner bore, the soot tube is introduced into a vitrification furnace and is held therein in vertical orientation by means of a holding device. Said device comprises a holding rod which extends from above through the inner bore of the soot tube and which is connected to a holding base on which the soot tube is standing with its lower end. The holding rod consists of a carbon fiber reinforced graphite (CFC; carbon fiber reinforced carbon), and it is enveloped in the area of the inner bore of the soot tube by a gas-permeable cladding tube of pure graphite. During vitrification the soot tube collapses onto the cladding tube of graphite, and entrapped gases can here escape through the gas-permeable cladding tube to the inside. Vitrified hollow cylinders with different inner diameters can be produced independently of the outer diameter of the holding rod by varying the thickness of the cladding tube. During collapsing of the soot tube, the width of the gap between the cladding tube and the inner wall of the soot tube turns out to be critical. A wide gap prevents the soot tube from shrinking onto the cladding tube, resulting in any undefined inner diameter in the hollow cylinder after sintering. Moreover, uncontrollable plastic deformations may arise. This may be accompanied by the formation of striae, which on the whole impairs the quality of the inner bore and of the vitrified hollow cylinder and also contributes to a reduced reproducibility of this method step. That is why a cladding tube is normally used filling the inner tube of the soot tube as much as possible. The inner diameter of the resulting hollow cylinder cannot be smaller than the outer diameter of the cladding tube.

Therefore, no method is known that permits an economic and reproducible production of hollow cylinders having a small inner diameter or a great ratio of outer diameter to inner diameter.

It is therefore the object of the present invention to indicate an economic method by means of which hollow cylinders of quartz glass can be obtained with a narrow inner bore through the soot method. A further object of the present invention consists in providing a device suited for performing the method.

As for the method, this object, starting from the above-indicated method, is achieved according to the invention in that during sintering a pressure difference is at least temporarily generated and maintained between a lower internal pressure prevailing in the inner bore of the soot tube and a higher external pressure applied outside the inner bore.

In the method according to the invention, a pressure difference is generated between the internal pressure prevailing in the inner bore and the external pressure during sintering of the still porous soot tube. It must here be borne in mind that the gas permeability of the porous soot tube promotes the permanent pressure compensation between the internal pressure and the external pressure, which must be counteracted by continuously sucking gas out of the inner bore. Hence, generation and maintenance of the pressure difference require both a sealing of the open faces of the inner bore and a continuous or intermittent aspiration of the inner bore. In addition, it is also possible to apply an increased pressure from the outside to the soot tube to be sintered.

It has also been found that the generation and maintenance of a pressure difference during collapsing of the inner bore stabilizes the deformation process and reduces or prevents undefined plastic deformations. The negative pressure in the inner bore contributes to an improved reproducibility in that it generates additional, inwardly acting forces during collapsing, so that accidental variations in other process parameters, which may lead to an undefined collapsing process, are compensated. A broad gap between the inner wall of the soot tube and the shaping element can thus also be closed in a reproducible manner without the formation of striae during collapsing of the soot tube.

During sintering the soot tube shrinks onto the shaping element projecting into the inner bore, so that said shaping element defines the inner contour and the bore diameter of the vitrified hollow cylinder. Particularly because of the wide gap between the shaping element and the inner wall of the soot tube and thus the necessarily strong plastic deformations during collapsing of the inner bore, the shaping element is indispensable for the formation of a predetermined small bore diameter.

The method according to the invention thereby makes it possible to adjust the outer diameter of the vitrified hollow cylinder substantially independently of that of the soot tube, and particularly to produce also such hollow cylinders whose inner diameter is much smaller than the outer diameter of the support.

An advantageous side-effect of the method of the invention is that vitrified hollow cylinders can be produced from a soot tube standard with different outer diameters, which reduces an otherwise required variability of the support types and simplifies storage.

The vitrification or collapsing of SiO₂ soot tubes in helium or vacuum is generally known. By comparison, according to the present invention a pressure difference is generated and maintained between internal pressure and external pressure, with the aim of producing a hollow cylinder of quartz glass having a small inner diameter that is predetermined by the outer contour of the shaping element arranged in the inner bore.

Advantageously, the shaping element is configured as an inner bore which projects into the inner bore and has a gas-permeable wall, the lower internal pressure in the inner bore being maintained by aspiration through the gas-permeable inner tube wall.

The inner tube serves not only as the shaping member defining the inner diameter of the vitrified hollow cylinder, but also forms part of an aspirating operation for the inner bore. To generate and maintain the pressure difference, gas is sucked off out of the inner bore via the inner tube wall and from there via the bore of the inner tube. The gas permeability of the inner tube wall even permits the impact of the aspirating action over the whole length of the inner bore when the soot tube has already collapsed at places onto the inner tube. This prevents gas inclusions that might lead to so-called “pockets”.

In this connection it has turned out to be useful when the inner tube wall has a permeability coefficient according to DIN 51935 of at least 10⁻² cm²/s.

The permeability coefficient is a measure of the permeability of a layer for gaseous substances due to a pressure gradient at both sides of the wall. As for the determination of said coefficient, various methods are known. The above-indicated lower limit follows from the determination method according to DIN 51935. An inner tube having a permeability coefficient below the said lower limit of 10⁻² cm²/s makes it more difficult, due to its high gas flow resistance, to generate and maintain an adequately low internal pressure in the inner bore, especially when additional gases are released at said place due to sintering. The permeability coefficient of the inner tube is limited upwards by the necessary mechanical strength.

When an inner tube consisting of a gas-tight material is used, the necessary gas permeability of the inner tube can be set by forming openings in the inner tube wall. This manufacturing effort for making openings in the inner tube wall is avoided in a preferred procedure in which an inner tube of a porous gas-permeable material is used.

Graphite and CFC have turned out to be suitable materials for this purpose.

These materials are thermally stable at the standard sintering temperatures and are inert to quartz glass. Tubes of graphite or CFC are obtainable in high purity and with different porosities.

It has turned out to be advantageous when the inner tube has a wall thickness in the range between 3 mm and 15 mm and an open porosity in the range between 10% and 25%.

A thin wall and a high porosity yield a particularly high gas permeability of the inner tube that may lead to a pronounced gas flow to the place of the smallest internal pressure. Such a gas flow may be detrimental to the setting of a desired temperature profile during sintering, especially when a temperature profile is desired that is homogeneous over the length of the soot tube, as in the case of isothermal sintering. A thick wall and a low porosity may lead to an inadequate aspiration and to the formation of a gas cushion around the inner tube, which may render a uniform collapsing of the soot tube onto the inner tube more difficult.

It is particularly for this reason that use is preferably made of an inner tube having a flow resistance smaller than the initial flow resistance of the soot tube.

The flow resistance of the soot tube increases with a decreasing gas permeability in the course of the sintering process. Therefore, the initial flow resistance at the beginning of the sintering process corresponds to the smallest flow resistance of the soot tube to be expected. The formation of gas cushions between the soot tube and the inner tube can be prevented in a reliable way by the use of an inner tube having an even smaller flow resistance.

In a first preferred variant of the method the soot tube is sintered by isothermal heating by a substantially homogeneous temperature field being produced over the length of the soot tube.

In this process the vitrification front travels over the whole soot tube length from the outside to the inside, which leads to a short sintering process.

A further acceleration of the sintering process is accomplished when in a first sintering phase in which the soot tube shows a higher gas permeability, a lower external pressure is maintained and when in a second sintering phase in which the soot tube shows a lower gas permeability, the external pressure is raised.

During the first sintering phase the soot tube is exposed to a gas pressure that is as low as possible to prevent the incorporation of gases and the formation of bubbles in the vitrified material. That is why the porous soot is preferably in contact with a gas phase under low pressure (vacuum) or with a gas phase which contains a gas rapidly diffusing into quartz glass, such as helium. The transition to the second sintering phase can be determined by measuring the internal pressure because with a decreasing gas permeability of the soot tube wall due to the continuous aspiration in the inner bore a lower pressure is set. During the second sintering phase the already consolidated outer wall of the soot tube is exposed to a higher external pressure, resulting in a greater pressure difference relative to the internal pressure that accelerates the collapsing process without an enhanced incorporation of gases into the wall having to be feared because of this.

Particularly preferably, the external pressure is raised in this sintering phase by introducing nitrogen into the furnace outside the inner bore.

The diffusion coefficient for the diffusion of nitrogen in quartz glass is comparatively small, so that bubbles filled with nitrogen disintegrate in glass melts only very slowly. The incorporation of nitrogen into the softened quartz glass must therefore be avoided as much as possible. However, due to the lower gas permeability of the outer wall portions of the soot tube in this sintering phase, there is no risk of any considerable indiffusion of nitrogen. The inner wall of the soot tube that is still porous and jeopardized as such in this respect is protected from contact with the nitrogen since the inner bore is closed. Advantages offered by the use of nitrogen instead of helium are its lower thermal conductivity, which counteracts an undesired heating up of furnace regions outside the heating zone, and its lower price.

It has turned out to be useful that the soot tube is exposed in the first sintering phase to a doping or purifying gas and in the second sintering phase to a pressure gas that differs from the doping or purifying gas.

The doping or purifying gas serves to adjust or change material properties of the SiO₂ soot. These measures are particularly effective in the first sintering phase in the case of porous soot. Chlorine-containing or fluorine-containing gases are for example used as doping or purifying gas. The pressure gas serves to effect or support the formation of the soot tube into the desired hollow cylinder of quartz glass. Since these measures are only taken in the second sintering phase in the case of a soot tube that is at least vitrified on the outer wall, a doping or purifying action by the gas atmosphere can no longer be expected. Therefore, gases are particularly suited as pressure gases that are less expensive or less toxic than doping or purifying gases. Inert gases or nitrogen are particularly suited therefor.

In another advantageous variant of the method, the soot tube is sintered zone by zone by continuously feeding the soot tube, starting with one end, to a heating area provided in the furnace.

The zonewise sintering facilitates the outdiffusion of gases contained in the soot tube because the surface thereof is only closed in a gas-tight manner gradually by vitrification. Moreover, the melt front that is uniformly progressing in axial direction prevents the inclusion of non-vitrified regions.

Especially with respect to a high reproducibility of a predetermined length of the vitrified hollow cylinder, a procedure has turned out to be especially useful in which the soot tube is fixed with its one end to a first holding element, and with its other end to a second holding element, the holding element distance between first and second holding element being adjustable during sintering.

The holding elements are structural parts that are fixed to the ends of the soot tube. They may simultaneously serve to seal the inner bore. It is essential that both ends of the soot tube are supported by means of the holding elements. The distance between first and second holding element remains constant during sintering, or it is changed. At a constant distance, the length contraction of the soot tube, which otherwise starts during sintering, is prevented. Moreover, upsetting of the hollow cylinder by gradually shortening the distance, or elongation by continuously increasing the distance, is possible. In these variants of the method, the ratio of outer diameter or inner diameter and wall thickness of the vitrified hollow cylinder can be influenced in a selective way. A deformation that is particularly uniform over the length of the hollow cylinder is achieved in the above-mentioned zonewise sintering variant when the distance is changed in linear dependence upon the feed rate of the soot body into the heating zone.

A further effect of the above-described holding operation at two sides is that the inner tube is relieved of the weight of the collapsing soot tube and thus requires only little mechanical stability. It can therefore be very thin and/or consist of porous material, for the mass of the soot body positioned underneath the heating zone is received during sintering by the lower supporting holding element, and the mass positioned above the heating zone is suspended from the upper holding element. During sintering both holding elements are loaded. Depending on the position of the heating zone, increased weights act either on the upper or the lower holding element. The soot tube can simultaneously be held suspended from the upper holding element and can also be supported by the lower holding element. In this respect the holding elements carry part of the weight of the soot tube during sintering, or they carry the whole weight. As a result, the shaping element that is arranged in the inner bore of the soot tube is freed or relieved of such a task, which permits its formation as a particularly filigree, thin and/or porous inner tube. This relief also eliminates the risk of deformation of the inner tube under the weight of the soot tube during sintering, with the consequence of a bent inner bore in the hollow cylinder of quartz glass, as is observed in the known methods.

It has turned out to be advantageous to seal the inner bore by means of plugs.

The plugs make it easier to observe the pressure difference between the internal pressure and the external pressure. The plugs consist of a high temperature-resistant material that is as pure as possible. Plugs can be made with little manufacturing effort from graphite-containing materials that are suited for this purpose.

Advantageously, the plugs are fixed at both sides to the soot tube and simultaneously serve as a holding element.

The plugs can here be inserted into the inner bore in frictional engagement or form-fit manner, for instance by being provided with a thread that is turned into the porous soot tube wall. The plugs themselves or parts thereof can also be embedded during the deposition process at the ends of the soot tube. Apart from their function to seal the inner bore, they also serve to hold the soot tube in that during sintering said plugs are supported either directly or indirectly through a further component by means of a holding device. The soot tube is thus connected at both sides to holding elements in the form of the plugs, by means of which it is held in vertical orientation during sintering, as has been explained above in more detail. The distance of the separately supported plugs can be kept constant during sintering, or it may be varied.

Furthermore, it has turned out to be advantageous to generate an atmosphere containing a purifying agent or dopant outside the inner bore.

The purifying agent or dopant is drawn by aspiration acting in the inner bore through the soot tube wall, resulting in a comparatively homogeneous concentration profile with a small gradient leading to a uniform purification or a homogeneous dopant distribution over the soot tube wall. Chlorine and chlorine-containing compounds are suited as purifying agents, and fluorine and fluorine-containing compounds as dopants.

Advantageously, the internal pressure is set to 1 mbar or less and is maintained.

In the area of the inner wall of the soot tube, porous soot material is present until the end of the sintering process, the porous soot material being jeopardized with respect to the incorporation of gases, as has already been explained further above. That is why the gas pressure should be set as low as possible in contact with said region of the soot tube during sintering.

Preferably, the porous soot material of the outer wall of the soot tube is also exposed to a gas pressure that is as low as possible. The lower the gas pressure, the smaller is the amount of gas diffusing into the soot tube. Moreover, the heat transport in the furnace chamber increases with an increasing gas amount, which leads to an increased temperature load on the furnace and to a higher energy consumption. That is why the pressure difference between the internal pressure and the external pressure is kept as small as possible and is set in the range between 1 mbar to 200 mbar.

Since during sintering by isothermal heating of the soot tube the vitrification process starts in the area of the outer wall, this procedure offers the possibility of an increase during the second sintering phase (as explained above) without the risk of an additional incorporation of gases.

The method according to the invention permits the manufacture of hollow cylinders having a small inner bore. It has turned out to be particularly suited for the manufacture of hollow cylinders with an inner diameter in the range between 20 mm and 45 mm.

As for the device, the above-mentioned object, starting from the device indicated at the outset, is achieved according to the invention in that the inner tube is closable and connected to a vacuum line, and that plugs are provided for closing the inner bore of the soot tube at both sides.

The device according to the invention permits reproducible collapsing of the soot tube onto the inner tube even in the case of a wide gap between the inner wall of the soot tube and the inner tube arranged in the inner bore. For this purpose the inner tube is closable and evacuable via a vacuum line. During evacuation gas is also sucked out of the inner bore because of the gas permeability of the inner tube wall, and a negative pressure as compared with the pressure acting on the outer jacket of the soot tube is thereby generated and maintained in the inner bore. The gas permeability of the inner tube wall even permits the impact of the aspirating action over the whole length of the inner bore of the soot tube when the tube has already collapsed at some places onto the inner tube, so that gas inclusions, which may lead to so-called “pockets”, are avoided. For setting the negative pressure in the inner bore, it is further necessary to prevent, if possible, any pressure compensation through a gas inlet via the open ends of the inner bore. To this end plugs are provided for closing the inner bore. Although in the ideal case the plug closure would thus be absolutely gas-tight, this is not needed because of the aspiration of the inner tube bore.

During sintering the soot collapses onto the inner tube, so that the outer dimensions and outer contour thereof define the inner dimensions and inner contour of the vitrified hollow cylinder. Especially in the case of a wide gap between inner tube and inner wall of the soot tube and the accompanying plastic deformations that are bound to be strong during collapsing of the inner bore, the shaping effect of the inner tube is indispensable for the formation of a predetermined small bore diameter.

Generation and maintenance of a pressure difference during collapsing of the inner bore additionally stabilize the deformation process, so that undefined plastic deformations are reduced or prevented. Even a wide gap between the inner wall of the soot tube and the inner tube can thus be closed in a reproducible manner without the formation of striae during collapsing of the soot tube. Reference is moreover made to the above explanations regarding the method of the invention.

Advantageous developments of the device according to the invention become apparent from the subclaims. Insofar as developments of the device as indicated in the subclaims follow the procedures indicated in subclaims regarding the method of the invention, reference is made to the above observations on the corresponding method claims for supplementary explanation. The configurations of the device of the invention as indicated in the remaining subclaims shall be explained in more detail in the following.

Due to a connection between soot tube and plugs, the latter can simultaneously serve to hold and support the soot tube in the furnace by the plugs being configured as an upper holding element and a lower holding element.

Preferably, the device according to the invention comprises a moving device by means of which at least the upper holding element is movable in the direction of the longitudinal axis of the soot tube.

The distance between the two holding elements can thereby be varied during sintering, thereby permitting an upsetting or elongation of the soot tube and the resulting hollow cylinder of quartz glass.

An inner tube that is longer than the soot tube is needed for elongating or extending the soot tube. Especially for the solution of this problem it has turned out to be advantageous when the upper plug comprises a bore in which the inner tube is displaceably guided in the direction of the longitudinal axis of the soot tube.

The sliding mounting of upper plug and inner tube relative to each other permits a gradual “further pushing” of the inner tube into the inner bore of the soot tube. Gas entry into the inner tube bore must here be avoided as much as possible. A bore that is closed in a gas-tight manner and has a sealing surface towards the outer jacket of the inner tube is suited for this purpose. As an alternative, the bore is configured as a through hole, and the upper end of the inner tube that projects out of the bore is gas-impermeable (sealed), thereby preventing the entry of gas via the inner tube wall into said region. Preferably, however, the problem is solved in that the bore is configured as a through hole through which the upper end of the soot tube extends into a chamber which seals the through hole to the outside.

With the help of the chamber, both the through hole and the upper end of the inner tube are sealed to the outside, so that neither a sealing of the upper end of the inner tube nor a tight design of the plug bore is required.

The method according to the invention shall now be explained in more detail with reference to an embodiment and a drawing, which shows in detail in

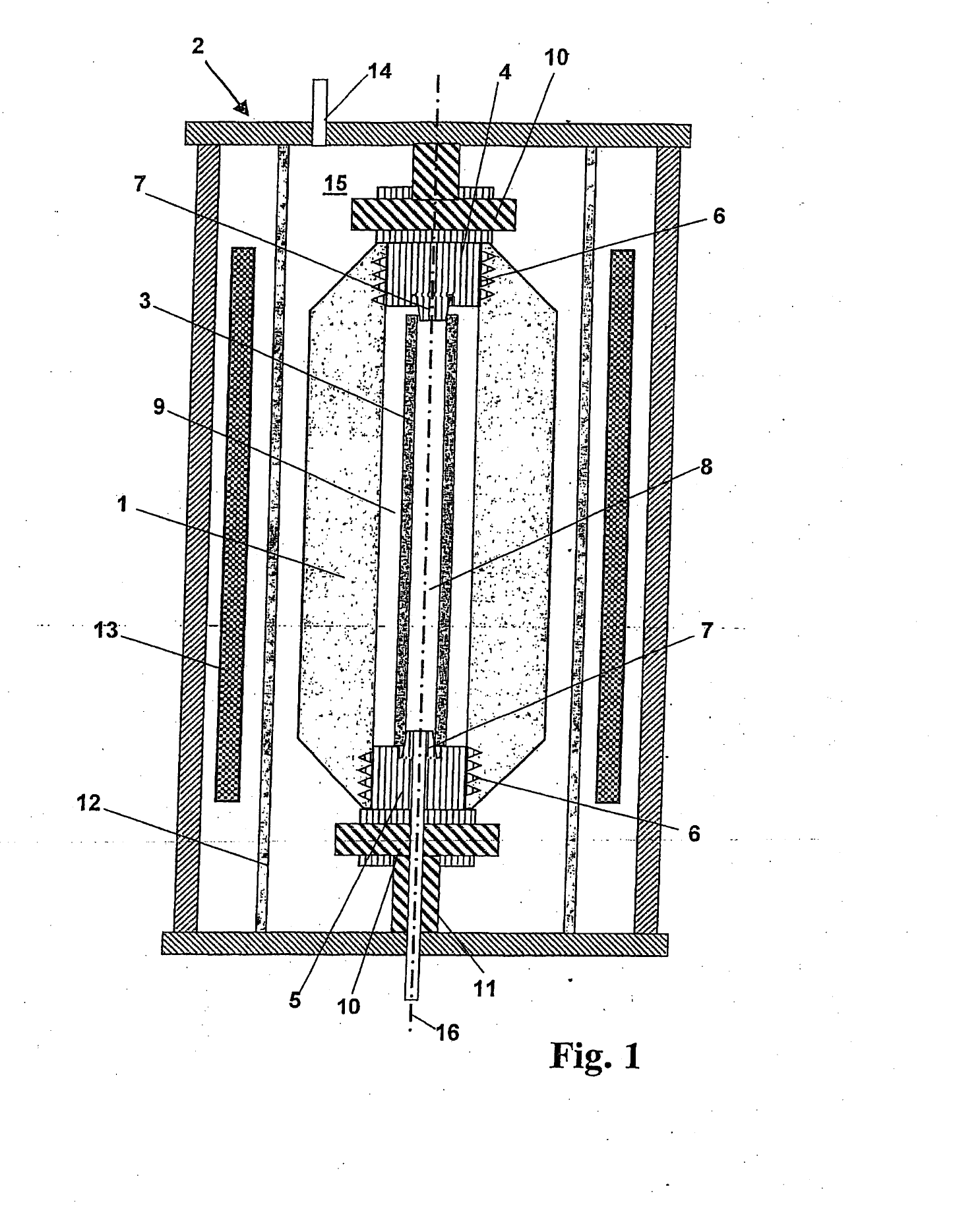

FIG. 1 the method according to the invention and the device according to the invention in a first embodiment in a schematic illustration, with a porous soot tube being held by means of a holding device in a vitrification furnace;

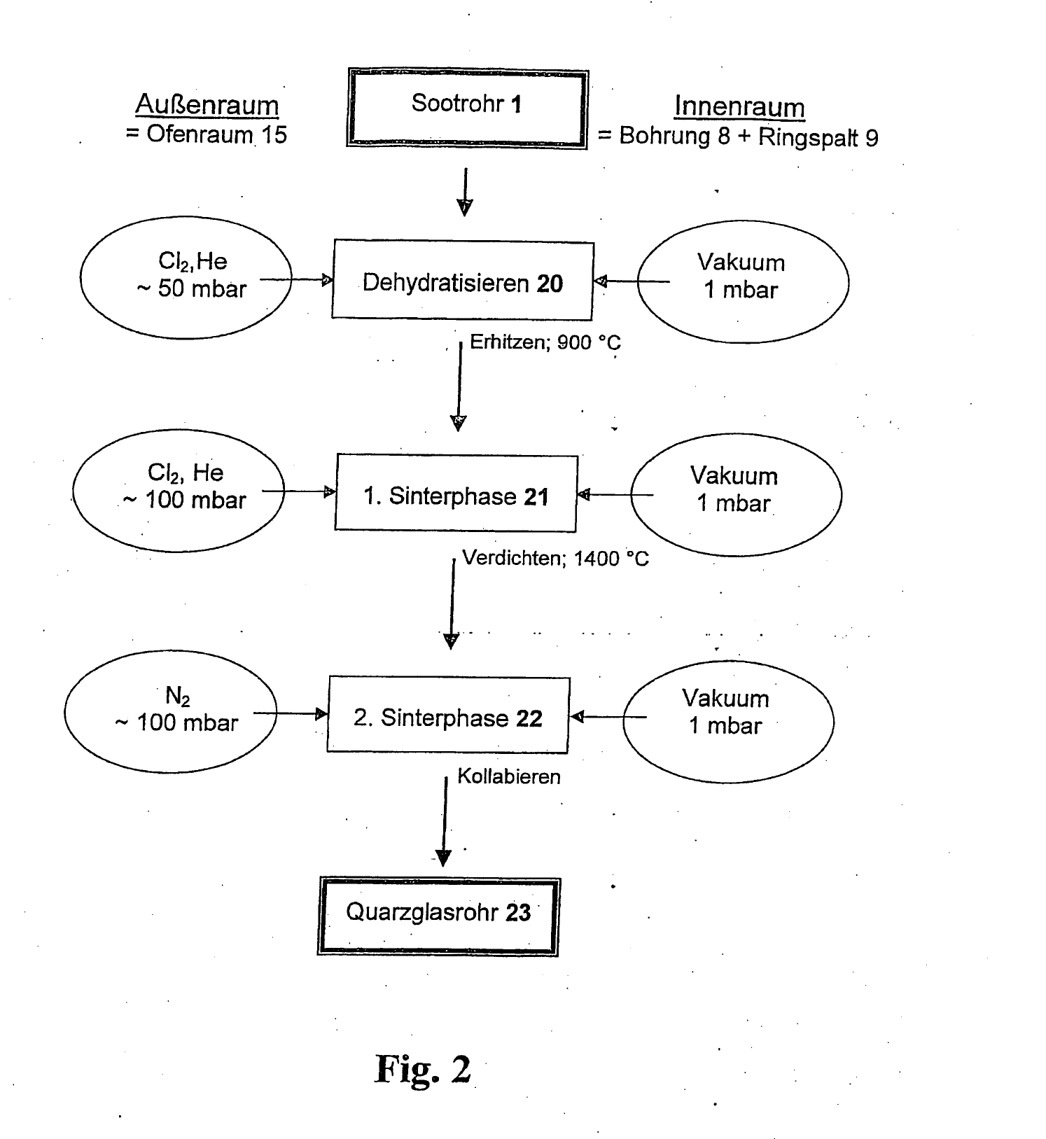

FIG. 2 a flow diagram for explaining a procedure for producing a hollow cylinder of quartz glass by way of the method according to the invention; and

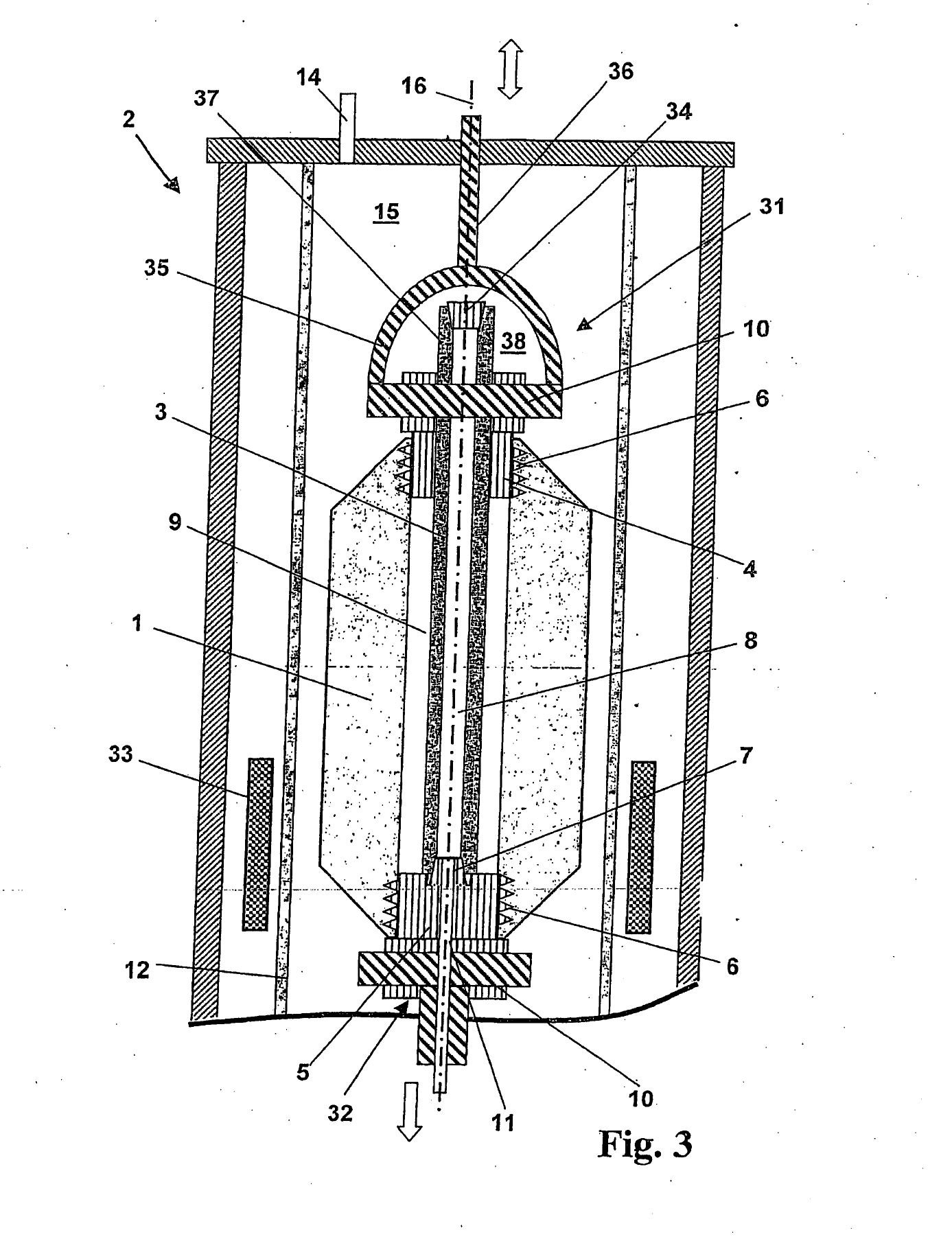

FIG. 3 a further embodiment of the method according to the invention and the device according to the invention, in a schematic illustration.

### EXAMPLE 1

FIG. 1 shows a porous SiO₂ soot tube 1 which for sintering purposes is held by means of a holding device in a vitrification furnace 2. The soot tube 1 has a length of 3 m, an outer diameter of 300 mm and an inner bore with an inner diameter of 50 mm.

An inner tube 3 of porous graphite extends in the inner bore of the soot tube 1. The inner tube 3 has an outer diameter of 30 mm, a wall thickness of 10 mm and a length slightly shorter than that of the soot tube 1. The permeability coefficient of the inner tube 3 as determined according to DIN 51935 is 10⁻¹ cm²/s, and it has an open porosity of 16%.

An annular gap 9 with a gap width of 10 mm remains between the inner wall of the soot tube and the inner tube 3.

The holding device comprises two graphite plugs 4, 5 and corresponding grippers 10 acting thereon, by means of which the graphite plugs 4, 5 are stationarily supported. Each of the graphite plugs 4, 5 is provided with a thread 6 and a closing cone 7. They are turned into the two face ends of the soot tube 1 and seal the annular gap 9 to the outside and also the bore 8 of the inner tube 3 into which the closing cones 7 project at both sides. There is some play in the direction of the central axis 15 for length compensation due to the thermal expansion of the inner tube 3. A vacuum line 11 which terminates in bore 8 and is connected to a vacuum pump is guided through the lower graphite plug 5.

The soot tube 1 is shielded by means of a muffle tube 12 of graphite relative to an annular heating element 13 which extends over the whole length of the soot tube 1. A line 14 for the gas inlet and for evacuating the muffle tube 12 terminates in the muffle tube interior 15.

An embodiment for the method according to the invention for producing a hollow cylinder of synthetic quartz glass using the device 1 shown in FIG. 1 shall now be described in more detail with reference to the flow diagram of FIG. 2.

SiO₂ soot particles are formed in the burner flame of a deposition burner by flame hydrolysis of SiCl₄, and these particles are deposited layer by layer on a support rod of Al₂O₃ rotating about its longitudinal axis, resulting in the formation of a soot body of porous SiO₂. The support rod which has a slightly conical external shape with a mean diameter of about 50 mm is removed after completion of the deposition process. The density of the resulting SiO₂ soot tube 1 is about 25% of the density of quartz glass. A transparent quartz glass tube is produced therefrom with the help of the method that will now be explained by way of example:

The porous inner tube 3 is inserted into the inner bore of the soot tube 1 and is fixed and centered therein by means of the graphite plugs 4, 5 screwed thereinto at both sides. The soot tube 1 is introduced into the vitrification furnace 2 and is held therein by means of the grippers 10 of the holding device in vertical orientation.

The sintering process comprises a first sintering phase 21 in which the soot tube wall is still gas-permeable, and a second sintering phase 22 in which a melt front traveling from the outside to the inside effects a gradual vitrification and thus a consolidation of the soot tube wall.

The first sintering phase 21 is preceded by a heating treatment lasting for 16 hours at a temperature of 900° C. and by a dehydration treatment 20, to which treatments the soot tube 1 is subjected for removing the hydroxyl groups introduced due to the manufacturing process. In the dehydration treatment 20, the whole muffle tube interior 15 is first evacuated completely by aspiration via the vacuum line 11 and via the line 14, and the soot tube 1 is subsequently treated at a temperature of around 900° C. in an atmosphere containing helium and chlorine. To this end an absolute pressure of about 1 mbar is generated and maintained in the bore 8 by continuous aspiration, the absolute pressure being also observed in the annular gap 9 (internal pressure) due to the gas permeability of the inner tube 3. At the same time a chlorine-containing gas is introduced via line 14 into the muffle tube interior 15, resulting in a higher pressure outside the soot tube 1 (external pressure: about 50 mbar) than in the annular gap 9. The chlorine-containing gas is sucked due to the pressure gradient between external pressure and internal pressure through the still completely porous soot tube wall from the outside to the inside. This yields a particularly efficient and uniform dehydration. This treatment is completed after about eight hours.

At the beginning of the first sintering phase 21, the gas mixture of chlorine and helium is still introduced via line 14 into the interior 15, namely in an amount which upon continuous evacuation of the bore 8 and thus of the annular gap 9 creates a pressure difference between the external pressure and the internal pressure of 100 mbar. Due to the pressure difference the gas mixture diffuses from the outside through the soot tube wall to the inside.

At the same time the soot tube 1 is heated under the action of this pressure difference to a temperature of about 1450° C., so that the soot tube 1 is gradually vitrified by a melt front progressing from the outer wall thereof from the outside to the inside.

As soon as a completely vitrified outer layer has been formed over the length of the soot tube 1, said layer will stop the further transportation of gas through the soot tube wall, so that the former target pressure difference of 100 mbar rises suddenly, thereby indicating the beginning of the second sintering phase 22. The evacuation of the bore 8 and of the annular gap 9 is continued in said phase 22, but the supply of the gas mixture consisting of chlorine and helium is terminated and, instead of this, nitrogen is introduced via line 14 into the interior 15 in such an amount that a pressure difference of about 100 mbar is created between the internal pressure and the external pressure. The thermal conductivity of nitrogen that is low in comparison with helium reduces the further heating up of the components of the vitrification furnace 2 that are located outside the heating element 13.

Due to the pressure difference, which is increased in the second sintering phase 22, the inner bore of the gradually vitrifying soot tube 1 collapses onto the inner tube 3 in a particularly uniform way. This tube has no supporting function because 5 of the separate mounting of the soot tube 1, and it can therefore be formed as a particularly filigree and thin-walled tube consisting of porous graphite.

The support of the soot tube 1 at both sides on the graphite plugs 4, 5 prevents a length contraction, which is otherwise observed during sintering of the soot tube 1, so that a quartz glass tube is obtained with exactly the predetermined length. Moreover, the inner tube 3 is fully relieved of load due to the support of the soot tube 1 on the graphite plugs 4, 5 and does thus not deflect.

After completion of the sintering process the inner tube 3 is removed. A quartz glass tube 23 is obtained having an outer diameter of 150 mm and a high-quality inner bore which is above all distinguished by a particularly small inner diameter of 30 mm.

The inner surface of the inner bore is straight, even and clean. Following a minor mechanical finishing treatment by way of honing the quartz glass tube 23 is suited for use as a jacket tube for producing preforms for optical fibers.

### EXAMPLE 2

In an alternative procedure, a quartz glass tube is produced, starting from a soot tube 1 as described above in Example 1, by the soot tube 1 being softened zone by zone and vitrified and collapsed onto the inner tube 3 in this process.

The vitrification furnace used for this purpose is diagrammatically shown in FIG. 3. Insofar as FIG. 3 uses the same reference numerals as FIG. 1, these will designate constructionally identical or equivalent structural parts and components of the device according to the invention, as have been explained above in more detail with reference to the description regarding FIG. 1.

The vitrification furnace shown in FIG. 3 differs from that shown in FIG. 1 substantially in that the annular heating element 33 just extends over a partial length of the soot tube 1, and that a moving device is provided in addition for moving the soot tube 1 continuously through the heating element 33. The moving device comprises an upper displacing device 31 acting on the lower graphite plug 4 (or on the gripper 10), and a lower displacing device 32 acting on the lower graphite plug 5. The displacing devices 31, 32 are movable upwards and downwards independently of each other, thereby permitting an upsetting or elongation of the soot tube 1 during sintering.

The embodiment according to FIG. 3 schematically shows an elongating operation performed during sintering. To this end the lower displacing device 32 is continuously moved downwards, so that the whole soot tube 1 is guided along the heating element 33 and heated and sintered zone by zone in this process. The upper displacing device 31 is movable upwards and downwards. In the embodiment, it is also moved continuously downwards during zonewise sintering for the purpose of elongating the soot tube 1, but at a slightly slower speed than the lower displacing device 32, so that during sintering the distance between the displacing devices 31, 32 and thus the distance between the graphite plugs 4, 5 is continuously increased, as shall be explained in more detail further below.

To permit an elongation or upsetting of the soot tube 1 during sintering, the upper graphite plug 4 is displaceable along the inner tube 3. The elongation of the soot tube 1 as shown in FIG. 3 requires an inner tube 1 that is longer than the initial length of the soot tube 1. To this end the graphite plug 4 is provided with a through hole through which the extended inner tube 3 extends upwards. The upper end 37 of the inner tube 3 projects into a chamber 38, which is formed by the gripper 10 and a cover 35 and surrounds the through hole of the graphite plug 4. With the help of the chamber 38 both the through hole and the upper end 37 of the inner tube 3 are sealed to the outside, so that gas penetration via the porous wall of the inner tube 1 into the bore 8 or via the through hole into the annular gap 9 is prevented. In addition, the upper end 37 of the inner tube 3 is sealed with a further plug 34. The cover 35 is engaged by a drawing rod 36 which is guided via a pressure-tight passage out of the furnace chamber 15.

The displaceable support of inner tube 3 and upper plug 4 relative to each other permits a continuous extension of the distance between upper and lower graphite plug during sintering by the inner tube 3 being continuously “pushed further” into the inner bore 9.

With reference to FIG. 3, the procedure according to Example 2 shall now be explained in more detail:

The sintering process proper is preceded by a dehydration treatment which does not differ from the one described above with reference to Example 1. A gas mixture of chlorine/helium is subsequently introduced via line 14 into the interior 15, namely in an amount that upon continuous evacuation of the bore 8 and thus of the annular gap 9 creates a pressure difference between the external pressure and the internal pressure of 50 mbar.

The sintering process starts in that the soot tube 1, starting with its lower end, is continuously supplied from above to the heating element 33 set to a temperature of about 1500° C. and is heated and vitrified therein zone by zone. While the soot tube 1 is sintered and collapsed, a melt front travels inside the soot tube 1 from the outside to the inside and from the bottom to the top at the same time. The internal pressure inside the bore 8 is held at 0.5 mbar during vitrification by way of continuous evacuation. During vitrification the soot tube 1 shrinks onto the inner tube 3 zone by zone. Gases escaping in this process are discharged via the still open-pored area of the soot tube 1 and via the gas-permeable inner tube 3, thereby preventing the formation of bubbles.

A further special feature of this procedure is that during zonewise sintering the grippers 10 are continuously moved apart by means of the displacing devices 31, 32 at a rate of 2 mm/min. To this end the lowering speed of the lower displacing device 32 is set to 7 mm/min, and the supply speed of the soot tube 1 to the heating zone 33 by means of the upper displacing device 31 to 5 mm/min. During the sintering process this will increase the distance by 40% as compared with the initial distance.

In this procedure the inner bore of the zonewise vitrified soot tube 1 also collapses onto the inner tube 3 particularly uniformly due to the pressure difference between internal pressure and external pressure, resulting in a quartz glass tube having a high-quality and straight inner bore that is especially distinguished by a particularly small inner diameter of 30 mm. The inner tube 3 has no supporting function whatsoever, which permits its formation in the form of a thin-walled and porous graphite tube.

This yields a quartz glass tube having a length of about 4.20 m, an outer diameter of 127 mm, and an inner diameter of 30 mm.

1. A method for producing a hollow cylinder of quartz glass, said method comprising: producing a porous soot tube with a central inner bore by depositing SiO₂ particles on an outer surface of a support rotating about a longitudinal axis; heating and sintering the soot tube in a furnace, the soot tube being supported by a holding device, the holding device comprising an elongated shaping element projecting into the inner bore and the soot tube being collapsed onto said shaping element so as to form the hollow cylinder, wherein during sintering a pressure difference is at least temporarily generated and maintained between an internal pressure in the inner bore of the soot tube and an external pressure that is higher than the internal pressure outside the inner bore.

2. The method according to claim 1, wherein the shaping element is an inner tube projecting into the inner bore and having a gas-permeable wall, and the internal pressure in the inner bore is maintained lower than the external pressure by aspiration over the gas-permeable wall.

3. The method according to claim 2, wherein the gas-permeable wall has a permeability coefficient according to DIN 51935 of at least 10⁻² cm²/s.

4. The method according to claim 2, wherein the inner tube is of a porous gas-permeable material.

5. The method according to claim 4, wherein the material is graphite or CFC.

6. The method according to claim 4, wherein the inner tube has a wall thickness in a range of 3 mm to 15 mm and an open porosity in a range of 10% to 25%.

7. The method according claim 2, wherein the soot tube has an initial flow resistance, and the inner tube has a flow resistance smaller than the initial flow resistance of the soot tube.

8. The method according to claim 1, wherein the soot tube is sintered by isothermal heating such that a substantially homogeneous temperature field is produced over a length of the soot tube.

9. The method according to claim 8, wherein in a first sintering phase the soot tube has a first gas permeability, and the external pressure is maintained at a lower pressure, and in a second sintering phase the soot tube has a second gas permeability lower than said first gas permeability, and the external pressure is increased.

10. The method according to claim 9, wherein the external pressure is increased by introducing nitrogen into the furnace outside the inner bore.

11. The method according to claim 9, wherein the soot tube is exposed in the first sintering phase to a doping or purifying gas and in the second sintering phase the soot tube is exposed to a pressure gas that differs from the doping or purifying gas.

12. The method according to claim 1, wherein the soot tube is sintered by continuously feeding the soot tube from one end thereof, to a heating area provided in the furnace and sintering the soot tube therein zone by zone.

13. The method according to claim 1, wherein the soot tube is fixed at one end thereof to a first holding element, and at another end to a second holding element a holding element distance between the first and second holding elements being adjustable during sintering.

14. The method according to claim 1 wherein the inner bore is sealed by plugs.

15. The method according to claim 14, wherein the plugs are fixed at both sides to the soot tube and serve as a holding element.

16. The method according to claim 13, wherein the holding element distance varies during sintering.

17. The method according to claim 13, wherein the holding element distance is constant during sintering.

18. The method according to claim 1, wherein an atmosphere containing a purifying agent or a dopant is generated outside the inner bore.

19. The method according to claim 1, wherein the internal pressure is set and maintained at 1 mbar or less.

20. The method according to claim 1, wherein the pressure difference between the internal pressure and external pressure is in a range of from 1 mbar to 200 mbar.

21. The method according to claim 1, wherein the hollow cylinder obtained has an inner diameter ranging from 20 mm to 45 mm.

22. A device for producing a hollow cylinder of quartz glass, said device comprising: a furnace for sintering a porous soot tube comprising an inner bore; a heating device heating and sintering the soot tube; a holding device holding the soot tube in vertical orientation in the furnace; and an elongated inner tube projecting into the inner bore and having a gas-permeable wall and onto which the soot tube is collapsed so as to form the hollow cylinder of quartz glass, wherein the inner tube is closable and connected to a vacuum line, and wherein plugs close the inner bore of the soot tube at both ends thereof.

23. The device according to claim 22, wherein the plugs are positively connected to the soot tube and serve as an upper holding element and as a lower holding element supporting the soot tube in the furnace.

24. The device according to claim 23, wherein a moving device is provided by which at least the upper holding element is movable in the direction of a longitudinal axis of the soot tube.

25. The device according to claim 23, wherein the upper plug has a bore in which the inner tube is displaceably guided in a direction of a longitudinal axis of the soot tube.

26. The device according to claim 25, wherein the bore is configured as a hole through which the upper end of the soot tube extends into a chamber sealing the hole.

27. The device according to claim 22, wherein the gas-permeable wall of the inner tube has a permeability coefficient according to DIN 51935 of at least 10⁻² cm²/s.

28. The device according to claim 22, wherein the inner tube is of a porous gas-permeable material.

29. The device according to claim 28, wherein the material is graphite or CFC.

30. The device according to claim 22, wherein the inner tube has a wall thickness in a range from 3 mm to 15 mm and an open porosity in a range from 10% to 25%.

31. The device according to claim 22, wherein the inner tube has a flow resistance less than an initial flow resistance of the soot tube.
